(19) United States
(12) Patent Application Publication
(10) Pub. No.: US 2012/0152581 A1
(43) Pub. Date: Jun. 21, 2012

(54) HAMMER SIDE BUFFER

(75) Inventors: Lauritz P. Pillers, II, McGregor, TX (US); Tommie L. Craven, Belton, TX (US); James G. Nickels, McGregor, TX (US)

(73) Assignee: Caterpillar Inc., Peoria, IL (US)

(21) Appl. No.: 12/972,447

(22) Filed: Dec. 18, 2010

(51) Int. Cl. B25D 17/24; B23P 6/00

(52) U.S. Cl. 173/162.1; 29/402.08

(57) ABSTRACT

A demolition hammer may include a housing having a distal end and a proximal end, a power cell disposed in the housing along a longitudinal axis and a side buffer positioned to support the power cell in the housing, wherein the housing forms a first retaining structure that prevents axial movement of the side buffer toward the proximal end. The housing may also form a second retaining structure that prevents inward radial movement of the side buffer and a third retaining structure that prevents outward radial movement of the side buffer.

### TECHNICAL FIELD

This disclosure relates generally to demolition hammers, and more specifically to a demolition hammer having a side buffer retained in the hammer by the hammer housing.

### BACKGROUND

Demolition hammers are used on work sites to break up hard objects such as rocks, concrete, asphalt, frozen ground, or other materials. The hammers may be mounted to machines, such as back hoes and excavators, or may be hand-held. Such hammers may include a pneumatically or hydraulically actuated power cell having an impact system operatively coupled to a tool. The impact system generates repeated, longitudinally directed forces against a proximal end of a tool disposed inside the hammer housing. The tool extends from the housing to engage the hard object. The forces against a proximal end of a tool are transmitted through the tool to break-up the hard object.

The power cell may be supported within the housing on one or more side buffers. The side buffers are typically held in place by the power cell and/or external fasteners. To remove and replace the side buffers, the hammer often needs to be removed from the machine it is mounted to and partially disassembled, such as removing an upper mounting plate and removing fasteners that hold the side buffer and other structure. As a result, the operator has to deal with additional parts, time and effort to service the hammer.

The present disclosure is directed toward one or more of the issues set forth above.

### SUMMARY OF THE DISCLOSURE

According to certain aspects of this disclosure, a demolition hammer may include a housing having a distal end and a proximal end, a power cell disposed in the housing along a longitudinal axis and a side buffer positioned to support the power cell in the housing, wherein the housing forms a first retaining structure that prevents axial movement of the side buffer toward the proximal end. The housing may also form a second retaining structure that prevents inward radial movement of the side buffer and a third retaining structure that prevents outward radial movement of the side buffer.

In another aspect of the disclosure, a method for replacing a side buffer in a demolition hammer having a power cell supported within a housing along a longitudinal axis between the side buffer and a top plate, may include moving the power cell within the housing axially toward the top plate to relieve pressure from the side buffer, removing the side buffer from the housing in a radially outward direction, inserting a replacement side buffer into the housing in a radially inward direction, and moving the power cell within the housing axially away from the top plate such that the replacement side buffer supports the power cell within the housing

In another aspect of the disclosure, a side buffer for a demolition hammer is configured to cooperate with structure formed by the housing of the hammer to be self-retained in the housing without contribution from external fasteners or a power cell. In one embodiment, the side buffer includes an upper surface, a pair of first angled surfaces adjacent the upper surface, a lower surface substantially parallel to the upper surface, a lip extending from the lower surface, a back surface connecting the upper surface to the lower surface, and a pair of recesses formed in the back surface on either side of a central axis.

### BRIEF DESCRIPTION OF THE DRAWINGS

FIG. 1 is a diagrammatic illustration of a machine having a demolition hammer.

FIG. 2 is a partial exploded view of an embodiment of a demolition hammer assembly according to the present disclosure.

FIG. 3 is a perspective view of an embodiment of a housing for the hammer of FIG. 2, enlarged to show the mounting location for a side buffer.

FIG. 4 is a perspective view of the housing of FIG. 3 with an outer shell removed to further show the mounting location of a side buffer.

FIG. 5 is partial cross-sectional view of hammer of FIG. 3.

FIG. 6 is back view of the side buffer of FIG. 3.

FIG. 7 is a side view of the side buffer of FIG. 3.

FIG. 8 is a bottom view of the side buffer of FIG. 3.

### DETAILED DESCRIPTION

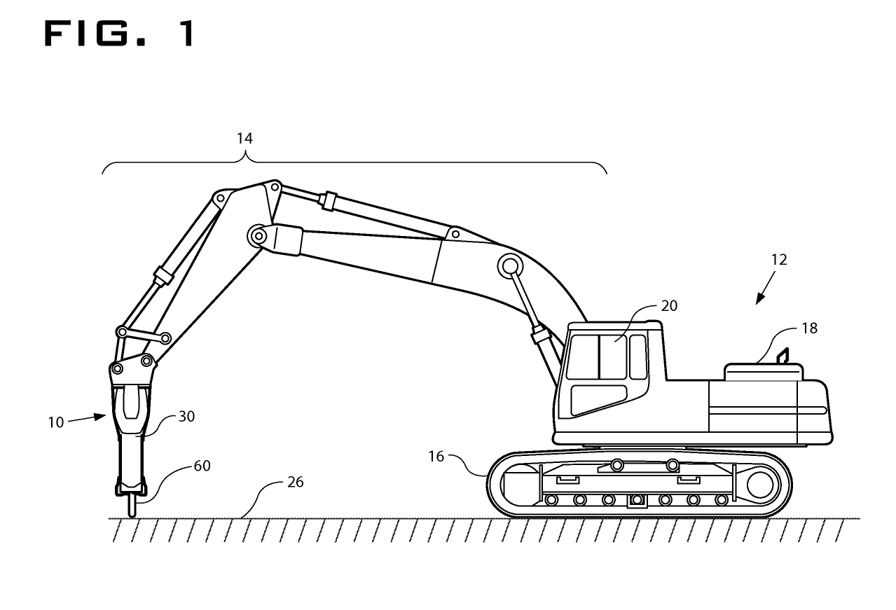

Referring to FIG. 1, a demolition hammer 10 is attached to a machine 12. Machine 12 may embody a fixed or mobile machine that performs some type of operation associated with an industry such as mining, construction, farming, transportation, or any other industry known in the art. For example, machine 12 may be an earth moving machine such as a backhoe, an excavator, a dozer, a loader, a motor grader, or any other earth moving machine. Machine 12 may include an implement system 14 configured to move the demolition hammer 10, a drive system 16 for propelling the machine 12, a power source 18 that provides power to implement system 14 and drive system 16, and an operator station 20 for operator control of implement system 14 and drive system 16.

Power source 18 may embody an engine such as, for example, a diesel engine, a gasoline engine, a gaseous fuel-powered engine or any other type of combustion engine known in the art. It is contemplated that power source 18 may alternatively embody a non-combustion source of power such as a fuel cell, a power storage device, or another source known in the art. Power source 18 may produce a mechanical or electrical power output that may then be converted to hydraulic pneumatic power for moving the implement system 14.

Implement system 14 may include a linkage structure acted on by fluid actuators to move the hammer 10. The linkage structure of implement system 14 may be complex, for example, including three or more degrees of freedom. The implement system 14 may carry the hammer 10 for breaking an object or ground surface 26.

The structure and operation of a demolition hammer are briefly described below. Demolition hammers are known in the art, and since it will be apparent to one skilled in the art that various aspects of the disclosed housing and side buffers may be used with a variety of demolition hammers, a detailed description of all the components and operation of a demolition hammer is not provided.

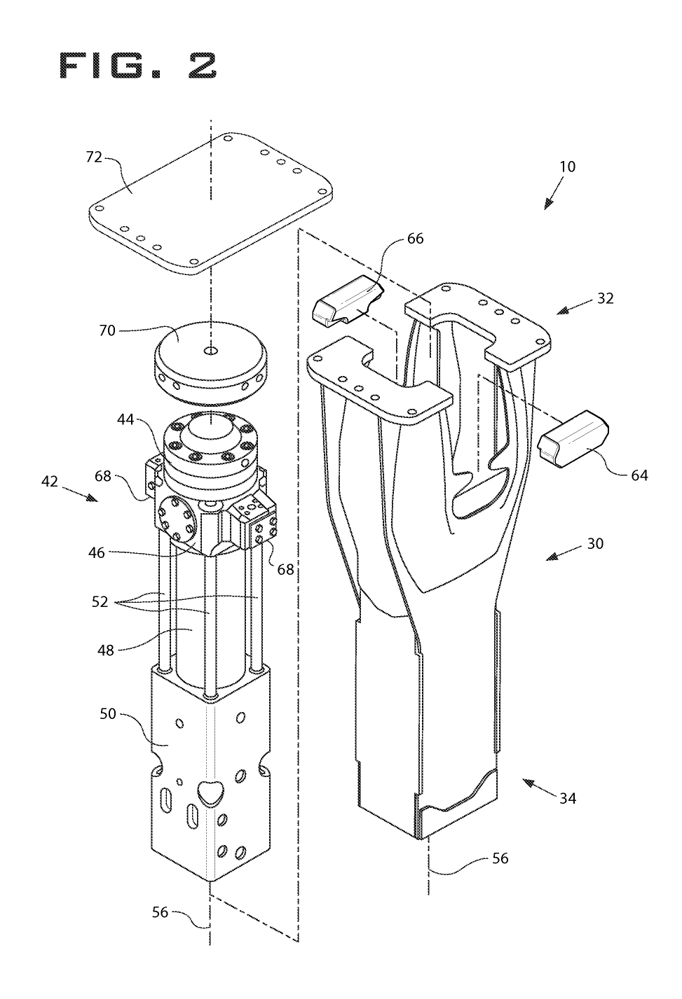

Referring to FIG. 2, the exemplary hammer 10 includes a hollow housing 30 having a proximal end 32 and a distal end 34. A power cell 42 is disposed inside the housing 30. The power cell 42 includes several internal components of the hammer 10. In the depicted embodiment, the power cell 42 includes an accumulator assembly 44, a valve assembly 46, an impact system 48, and a front head 50. The accumulator assembly 44 is mounted to the valve assembly 46. Tie rods 52 are used to hold the hammer 10 together by sandwiching the impact system 48 between the front head 50 and the accumulator assembly/valve assembly 44/46. The impact system 48 includes a piston (not shown) that extends into the front head 50. The piston is operatively positioned within the power cell 42 to move along a longitudinal axis 56. A distal portion of the power cell 42 includes a tool 60 (FIG. 1) that is operatively positioned to move along the longitudinal axis 56.

The hammer 10 may be powered by any suitable means, such as pneumatically-powered or hydraulically-powered. For example, a hydraulic or pneumatic circuit (not shown) may provide pressurized fluid to drive the piston toward the tool 60 during a work stroke and to return the piston during a return stroke. The hydraulic or pneumatic circuit is not described further, since it will be apparent to one skilled in the art that any suitable hydraulic or pneumatic systems may be used to provide pressurized fluid to the piston such as the hydraulic arrangement described in U.S. Pat. No. 5,944,120.

In operation, the piston is driven into the proximal end of the tool 60. The distal end of the tool 60 is positioned to engage an object or ground surface 26 (FIG. 1). The impact of the piston on the tool 60 may cause a shock wave that fractures the hard object (e.g. rock) causing it to break apart.

The power cell 42 is supported inside the housing 30 by a first side buffer 64 and a second side buffer 66. In the depicted embodiment, the first side buffer 64 is positioned on the opposite side of the housing 30 as the second side buffer 66. In other embodiments, more or less than two side buffers may be used and the side buffers may be positioned in any suitable manner to support the power. The valve assembly 46 of the power cell 42 includes shoulder surfaces 68 (or projections) that, when installed in the hammer, abuttingly engage the side buffers 64, 66 such that the side buffers support the weight of the power cell 42. A top buffer 70 is positioned onto the accumulator assembly 44 and an upper plate 72 is bolted onto the proximal end 32 of the housing 30. Thus, the power cell 42 is held between the side buffers 64, 66 (which engage the shoulder surfaces 68) and the upper plate 72 and the top buffer 70 (which engages the accumulator assembly 44).

The housing 30 and the side buffers 64, 66 are configured with corresponding structure such that retains the side buffers in the housing without contribution from the power cell or any external fasteners such as, pins, dowels, clips, bolts, etc. While in some embodiments, the housing need not necessarily restrict movement of the side buffers in all directions, in the depicted embodiment, the housing 30 forms structure that substantially prevents forward, rearward, upward, downward, or side-to-side movement of the side buffers 64, 66 relative to the housing. A person of ordinary skill in the art will appreciate that the housing 30 and the side buffers 64, 66 may be configured in a variety of ways to accomplish this. For example, the shape and size of the side buffers and the corresponding shape of the housing may vary with different embodiments.

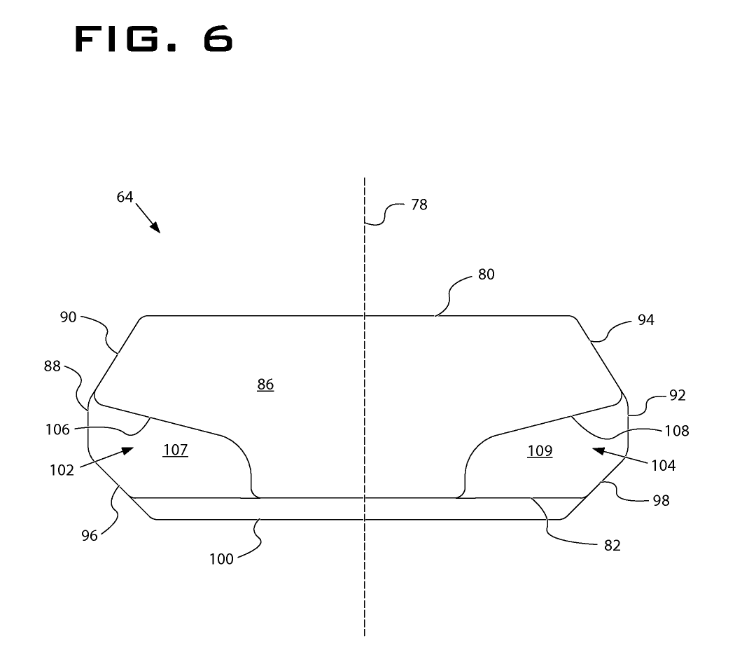

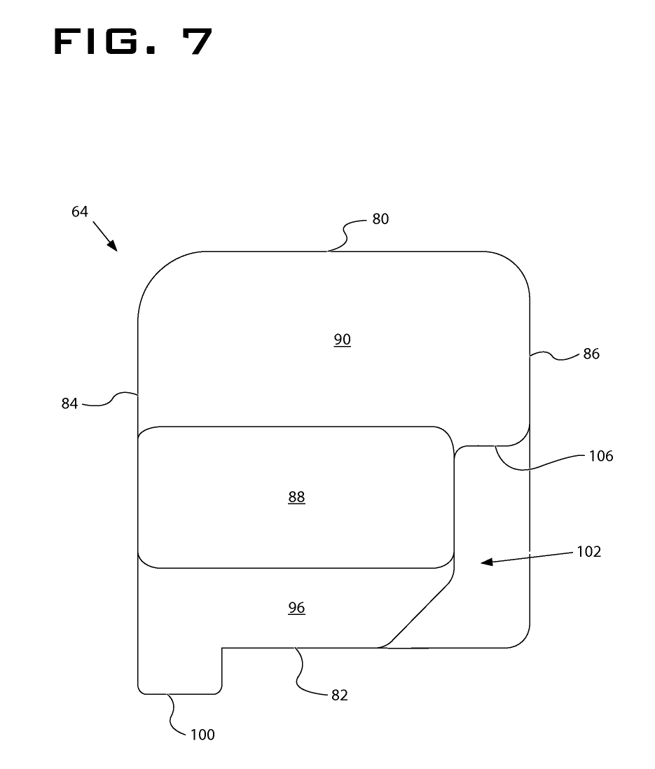

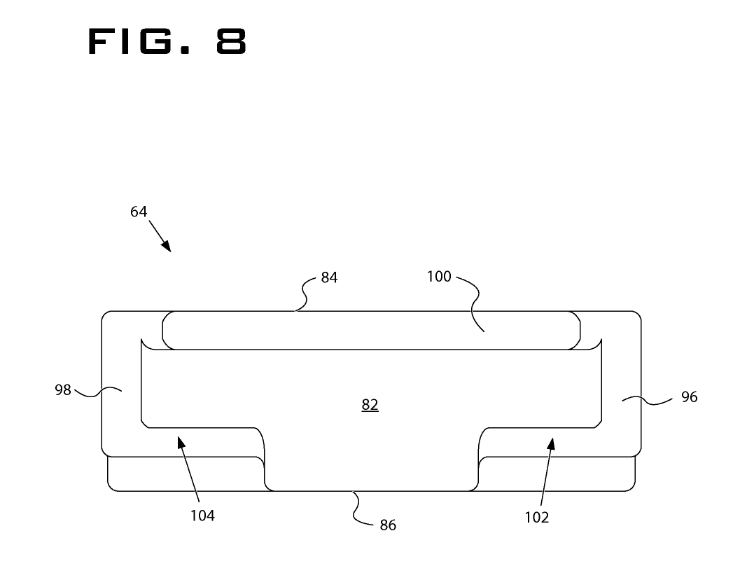

Referring to FIGS. 6-8, in the depicted embodiment, both side buffers 64, 66 are symmetric about central axis 78 and identical to each other, thus only the first side buffer 64 will be described in detail. In other embodiment, however, the side buffers 64, 66 may be configured differently and may not be symmetric.

The first side buffer 64 has an upper surface 80 that is substantially parallel to a lower surface 82, and a front face 84 that is substantially parallel to a back face 86. The upper surface 80 is configured to engage the shoulder surface 68 of the valve assembly 46. The upper surface 80 is connected to a first side surface 88 by a first upper angled surface 90 and is connected to a second side surface 92 by a second upper angled surface 94. The first side surface 88 is connected to the lower surface 82 by a first lower angled surface 96 and the second side surface 92 is connected to the lower surface 82 by a second lower angled surface 98. Extending from the lower surface 82 is lip 100 that extends laterally along the lower surface.

Adjacent the back face 86 are a first recess 102 and a second recess 104. The first recess 102 includes a first angled side wall 106 and a first back wall 107 and the second recess 104 includes a second angled side wall 108 and a second back wall 109.

The side buffers 64, 66 may be formed from a variety of suitable materials, such as rubber, plastic, or a combination of rubber and plastic. A suitable material for the side buffers 64, 66 should be stiff enough to adequately support the power cell 42 within the housing 30 but with some elasticity to dampen downward forces from the piston and tool. In the depicted embodiment, the first side buffer 64 is formed from rubber material.

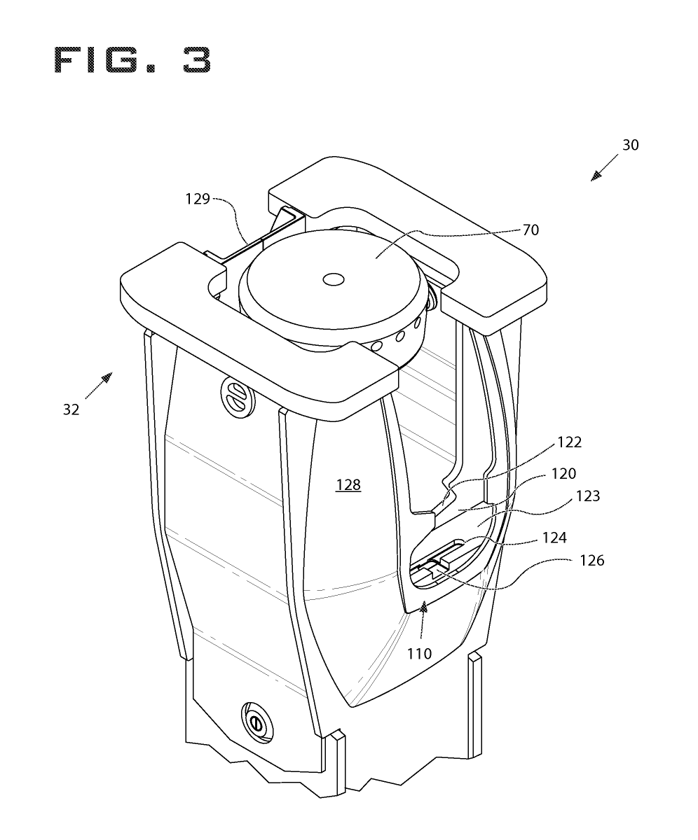

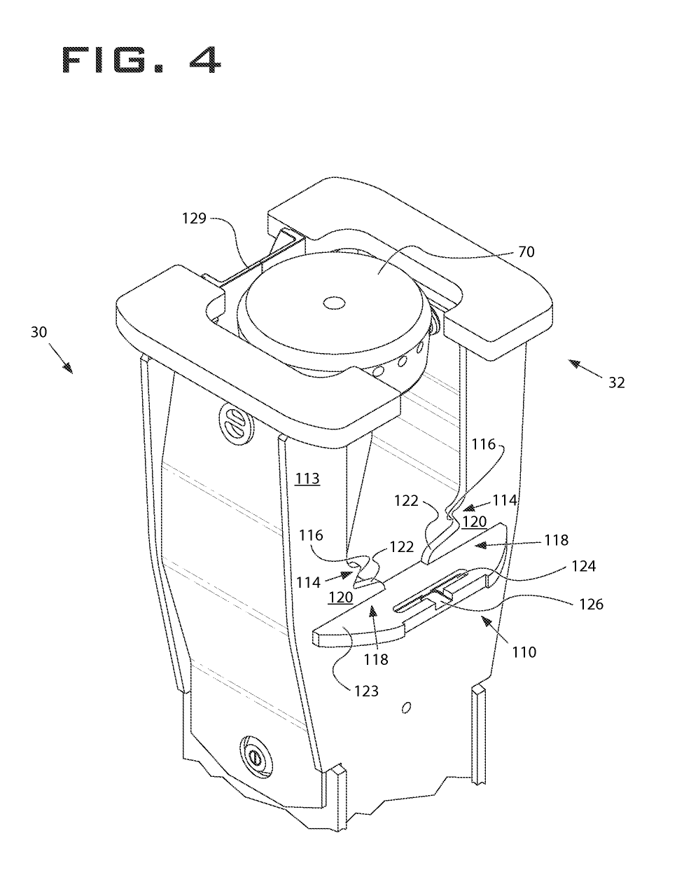

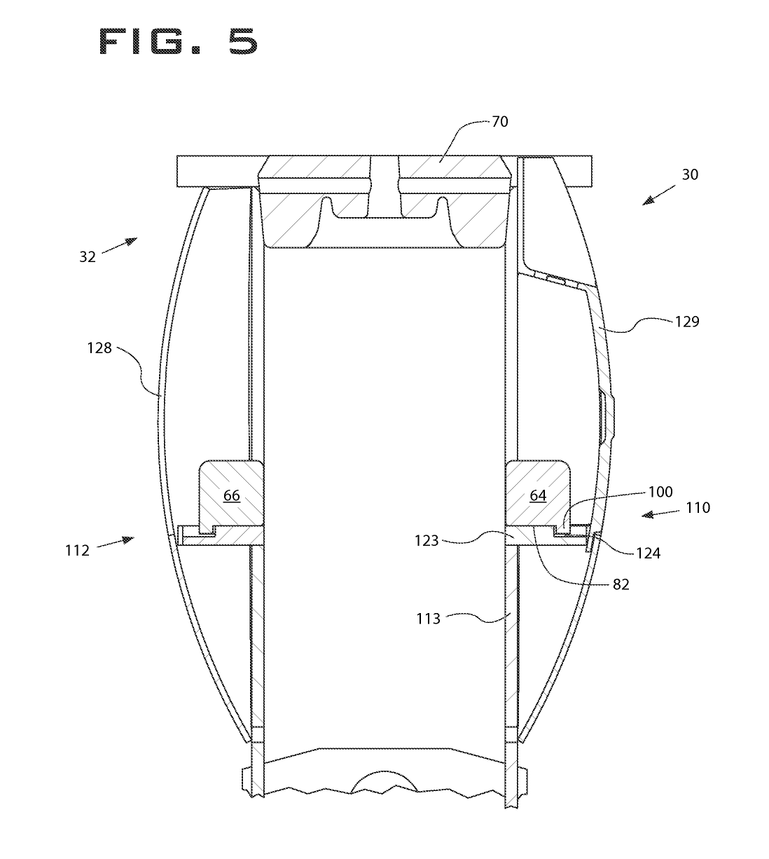

Referring to FIGS. 3-5, in the depicted embodiment, the housing 30 includes a first mounting area 110 for receive the first side buffer 64 and a second mounting area 112 for receiving the second side buffer 66. Both the first mounting area 110 and the second mounting area 112 may be substantially identical, thus only the first mounting area 110 is described in detail. In other embodiments, however, the first and second mounting areas 110, 112 may be configured differently.

The first mounting area 110 may be formed in a variety of ways. In the depicted embodiment, the first mounting area 110 is formed by a first plate 113 that includes a first retaining structure 114 configured to substantially prevent axial movement of the first side buffer 64 toward the proximal end 32 of the housing 30. The first retaining structure 114 includes first angled side surfaces 116 that are configured to conform to the first upper angled surface 90 and the second upper angled surface 94.

The first plate 113 also includes a second retaining structure 118 configured to substantially prevent inward radial movement of the first side buffer 64. The second retaining structure 118 is configured to be received in the first and second recesses 102, 104. The second retaining structure includes front faces 120 configured to engage the back walls 107, 109 of the first and second recesses 102, 104 and includes second angled side surfaces 122 configured to clear the first and second angled side walls 106, 108 of the first and second recesses 102, 104.

The first mounting area 110 is also formed by a second plate 123 that includes a third retaining structure 124 configured to substantially prevent outward radial movement of the first side buffer 64. The third retaining structure 124 is formed as a groove in the second plate 123 configured to receive the lip 100. A slot 126 is formed in the second plate 123 extending radially outward from the third retaining structure 124. An outer plate 128 is attached to the first plate 113 to form an outer shell with a cover 129 to complete the outer shell for the hammer.

When installed in the housing 30, the lower surface 82 of the first side buffer 64 contacts the second plate 123 and the lip 100 is received within the third retaining structure 124. The first angled side surfaces 116 of the first retaining structure 114 are positioned closely adjacent to or in abutting engagement with the first upper angled surface 90 and the second upper angled surface 94. The front faces 120 of the second retaining structure 118 are received in the first and second recesses 102, 104 and are positioned closely adjacent to or in abutting engagement with the back walls 107, 109. Further, the second angled side surfaces 122 are positioned closely adjacent to the first and second angled side walls 106, 108.

### INDUSTRIAL APPLICABILITY

The disclosed side buffers 64, 66 may be used in the demolition hammer 10 to support the power cell 42 within the housing 30. The disclosed side buffers 64, 66 and the housing 30 cooperate such that the side buffers are held in the hammer 10 by the housing 30 without contribution from the power cell 42 or any external fasteners. The side buffers 64, 66 and housing 30 are also configured such that the side buffers can be removed from the hammer 10 and replaced without having to remove the upper plate 72 from the hammer. As a result, servicing the side buffers 64, 66 can to be accomplished quickly and easily.

When installed in the hammer 10, each side buffer 64, 66 is substantially prevented from moving by retaining structure formed as part of the housing 30. For example, the first retaining structure 114 substantially prevents the first side buffer 64 from moving axially toward the proximal end 32 of the hammer 10 and moving laterally since it overlaps the upper angled surfaces 90, 94 of the first side buffer 64. The second retaining structure 118 substantially prevents the first side buffer 64 from moving radially inward and moving laterally since it is received within the recesses 102, 104 and abuts the back walls 107, 109 and angled side walls 106, 108 of the recesses. The third retaining structure 124 substantially prevents the first side buffer 64 from moving radially inward, radially outward, and laterally since the lip 100 on the first side buffer 64 is received in the third retaining structure 124.

The retaining structure, however, is formed such that the upper surface 80 of the first side buffer 64 may be engaged by the shoulder surface 68 of the valve assembly 46 to support the weight of the power cell 42 in the housing 30. During use of the hammer 10, the side buffers 64, 66 absorb and dampen some of the high downward forces caused by the piston (not shown) and tool 60. Periodically, the side buffers 64, 66 will degrade and need replaced.

The side buffers 64, 66 in the present disclosure can be removed and replaced without removing the hammer 10 from the machine 12 or removing the upper plate 72. To do so, the power cell 42 is moved relative to the housing 30, axially toward the upper plate 72, to relieve pressure from the side buffers 64, 66. This can be accomplished, for example, by actuating the machine 12 to apply a down force on the hammer 10 and moving the distal end of the tool 60 into contact with a hard stationary object. Once pressure is relieved from the first side buffer 64, the underside (lower surface 82) of the first side buffer 64 can be accessed via the slot 126 and the first side buffer 64 can be pried clear of the retaining structure. For example, a tool with a flat end (e.g. a pry bar, crow bar, standard screwdriver, etc.) can inserted under the first side buffer 64 to pry it out of position. Once clear of the retaining structure, the first side buffer 64 can be removed from housing 30 in a radially outward direction. A new side buffer can be inserted in a similar manner and tapped into place with a tool, such as a hammer.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. The demolition hammer, comprising:
a housing having a distal end and a proximal end;
a power cell disposed in the housing along a longitudinal axis; and
a side buffer positioned to support the power cell in the housing, wherein the housing forms a first retaining structure that prevents axial movement of the side buffer toward the proximal end.

2. The demolition hammer according to claim 1 wherein the side buffer includes an upper surfaces that engages a shoulder on the power cell and an surface adjacent to and extending traverse to the upper surface that engages the first retaining structure.

3. The demolition hammer according to claim 1, wherein the housing forms a second retaining structure that prevents inward radial movement of the side buffer.

4. The demolition hammer according to claim 3, wherein side buffer include a back surface having a recess and at least a portion of the second retaining structure is received in the recess.

5. The demolition hammer according to claim 3, wherein the housing forms a third retaining structure that prevents outward radial movement of the side buffer.

6. The demolition hammer according to claim 5 wherein the housing further comprises a first plate and a second plate, and wherein the first retaining structure and the second retaining structure are formed by the first plate and the third retaining structure is formed by the second plate.

7. The demolition hammer according to claim 5, wherein the third retaining structure is a groove.

8. The demolition hammer according to claim 7, wherein the side buffer includes a lip that is received in the groove.

9. The demolition hammer according to claim 7 further comprising a slot extending radially outward from the groove for providing access to a lower surface of the side buffer.

10. A method for replacing a side buffer in a demolition hammer having a power cell supported within a housing along a longitudinal axis between the side buffer and a top plate, comprising:
moving the power cell within the housing axially toward the top plate to relieve pressure from the side buffer;
removing the side buffer from housing in a radially outward direction;
inserting a replacement side buffer into the housing in a radially inward direction; and
moving the power cell within the housing axially away from the top plate such that the replacement side buffer supports the power cell within the housing.

11. The method of claim 10 wherein removing the side buffer from housing further comprises:
accessing with a tool an underside portion of the side buffer via a slot in the housing; and
prying the side buffer with the tool to clear the side buffer from retaining structure of the housing.

12. The method of claim 10 wherein the power cell includes a work tool extending from a distal end of the hammer and wherein moving the power cell within the housing axially toward the top plate further comprises pressing a distal end of the tool into a stationary object.

13. The method of claim 10 wherein the hammer is mounted to a machine and wherein pressing a distal end of the tool into a stationary object further comprises actuating the machine to move the distal end of the tool into the stationary object.

14. A side buffer for a demolition hammer having a power cell disposed within a housing, the side buffer, comprising:
an upper surface;
a lower surface substantially parallel to the upper surface;
a lip extending from the lower surface;
a back surface connecting the upper surface to the lower surface; and
a pair of recesses formed in the back surface on either side of a central axis.

15. The side buffer according to claim 14 further comprising a pair of first angled surfaces adjacent the upper surface.

16. The side buffer according to claim 14 wherein the side buffer is substantially symmetric about the central axis.
